(19) United States
(12) Patent Application Publication
(10) Pub. No.: US 2025/0135773 A1
(43) Pub. Date: May 1, 2025

(54) LIQUID DISCHARGE HEAD, LIQUID DISCHARGE APPARATUS, METHOD FOR MANUFACTURING LIQUID DISCHARGE HEAD

(71) Applicant: Tsutoh AOYAMA, KANAGAWA (JP)

(72) Inventor: Tsutoh AOYAMA, KANAGAWA (JP)

(21) Appl. No.: 18/835,738

(22) PCT Filed: Feb. 6, 2023
(86) PCT No.: PCT/IB2023/051020

§ 371 Date: Aug. 5, 2024

(30) Foreign Application Priority Data
Mar. 11, 2022 (JP) 2022-038660

(51) Int. Cl. B41J 2/14; B41J 2/16

(52) U.S. Cl. CPC B41J 2/14233; B41J 2/1628; B41J 2/1642; B41J 2002/14266

(57) ABSTRACT

A liquid discharge head includes: a nozzle configured to discharge a liquid; a substrate including a pressure chamber communicating with the nozzle; and an electromechanical conversion element, the liquid discharge head configured to drive the electromechanical conversion element to pressurize ink in the pressure chamber and discharge the liquid from the nozzle, the liquid discharge head provided with a surface layer having lyophilicity with respect to the liquid on inner peripheral surfaces of the nozzle and the pressure chamber.

### TECHNICAL FIELD

The present embodiment relates to a liquid discharge head, a liquid discharge apparatus, and a method for manufacturing a liquid discharge head.

### BACKGROUND ART

There is a liquid discharge head that drives an electromechanical conversion element to discharge a liquid in a pressure chamber communicating with a nozzle from the nozzle. Patent Literature 1 discloses, as the liquid discharge head, a liquid discharge head in which a substrate is etched with a sulfur hexafluoride (SF6) gas to form a pressure chamber.

### CITATION LIST

### Patent literature

### [PTL 1]

Japanese Patent No. 5663538

### SUMMARY OF INVENTION

### Technical Problem

However, there is a problem in filling property of a liquid.

### Solution to Problem

A liquid discharge head includes: a nozzle configured to discharge a liquid; a substrate including a pressure chamber communicating with the nozzle; and an electromechanical conversion element, the liquid discharge head configured to drive the electromechanical conversion element to pressurize ink in the pressure chamber and discharge the liquid from the nozzle, the liquid discharge head provided with a surface layer having lyophilicity with respect to the liquid on inner peripheral surfaces of the nozzle and the pressure chamber.

### Advantageous Effects of Invention

According to the present embodiment, the filling property of the liquid may be enhanced.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a cross-sectional view schematically illustrating a nozzle vibration type liquid discharge head in the present embodiment.

FIG. 2 is a perspective view schematically illustrating the liquid discharge head.

FIG. 3 is an enlarged cross-sectional view of a portion X in FIG. 1.

FIG. 4 is a diagram for explaining a step of forming a drive circuit, wiring, and a diaphragm on a channel substrate.

FIG. 5 is a diagram for explaining a step of forming a first electrode layer, a piezoelectric layer, and a second electrode layer on the diaphragm.

FIG. 6 is a diagram for explaining a step of forming a first insulating film.

FIG. 7 is a diagram for explaining a step of forming a plurality of contacts.

FIG. 8 is a diagram for explaining a step of forming lead-out wiring.

FIG. 9 is a diagram for explaining a step of forming a second insulating film.

FIG. 10 is a diagram for explaining a step of forming a nozzle forming portion.

FIG. 11 is a diagram for explaining a step of forming a nozzle and a pad opening.

FIG. 12 is a diagram for explaining a step of forming a pressure chamber.

FIG. 13A is a diagram for explaining formation of the pressure chamber of the present embodiment.

FIG. 13B is a diagram for explaining formation of a conventional pressure chamber.

FIG. 14 is a diagram for explaining a step of forming a protective film.

FIG. 15 is a diagram for explaining a step of forming a liquid repellent film.

FIG. 16 is a schematic explanatory diagram of a printer according to the present embodiment.

FIG. 17 is an explanatory plan view of an example of a head device of the printer.

FIG. 18 is an explanatory plan view of a substantial part of another printer.

FIG. 19 is an explanatory side view of a substantial part of the printer of this example.

FIG. 20 is an explanatory plan view of a substantial part of the liquid discharge device according to this example.

FIG. 21 is an explanatory front view of the liquid discharge device according to this example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, an embodiment in which the present embodiment is applied to a liquid discharge head 1 provided in a liquid discharge apparatus is described below.

The liquid discharge head 1 may be referred simply as “head 1” below.

The present embodiment is not limited to the embodiments described below, and changes such as other embodiments, additions, modifications, and deletions may be made within the scope that may be conceived by those skilled in the art, and any aspect is included in the scope of the present embodiment as long as the function and effect of the present embodiment are achieved.

The head 1 according to the present embodiment is a nozzle vibration type liquid discharge head that varies a pressure in a pressure chamber by an actuator including a nozzle to discharge a liquid in the pressure chamber from the nozzle. The nozzle vibration type is characterized in that droplets may be splashed with a smaller force than that with a general unimorph piezo head (that vibrates a surface facing a surface having a communication port communicating with a nozzle of a pressure chamber to discharges a liquid), and may achieve power saving of the actuator.

When a nozzle density is increased, a space for laying out wiring for applying a voltage is limited, and wiring construction on a substrate surface becomes difficult. When constructing the wiring and a drive circuit in the substrate, the wiring may be laid out even in a configuration having a high nozzle density. In general, lead zirconate titanate (PZT) is widely used as a material of a piezoelectric element because of its high piezoelectric characteristic, but film formation/crystallization temperature of PZT should be 600° C. or higher. When PZT is used as the material of the piezoelectric element, the drive circuit and the wiring in the substrate may not withstand high temperature, so that a piezoelectric material having lower film formation temperature than that of PZT should be used as the piezoelectric material. In this case, it is forced to select a material having a lower piezoelectric characteristic than that of PZT. However, the nozzle vibration type has a characteristic that the droplets may be splashed with a smaller force than that with the general unimorph piezo head as described above, so that the droplets may be satisfactorily splashed even when a material having a lower piezoelectric characteristic than that of PZT is selected. Therefore, a piezoelectric material such as a non-lead material having low film formation/crystallization temperature and small power may also satisfactorily splash droplets. As a result, the wiring and drive circuit may be constructed in the substrate, and the density may be increased.

Moreover, since the nozzle vibration type may reduce a volume of the pressure chamber, the head may be downsized.

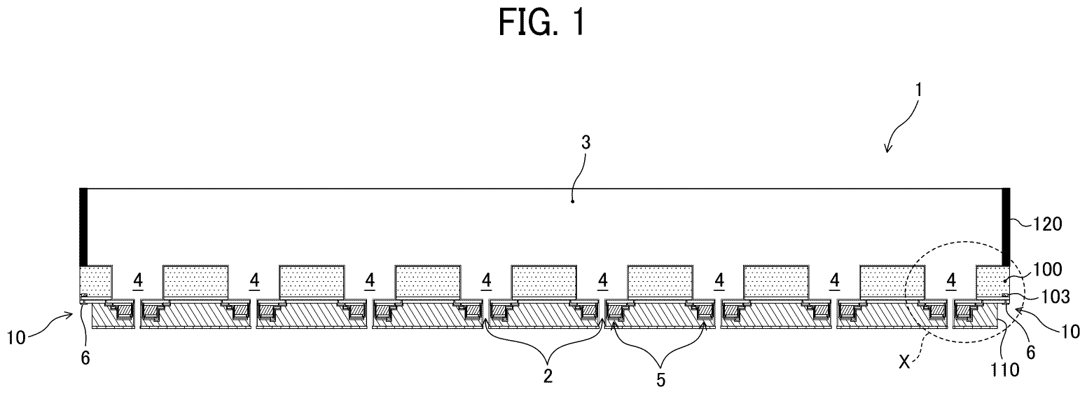

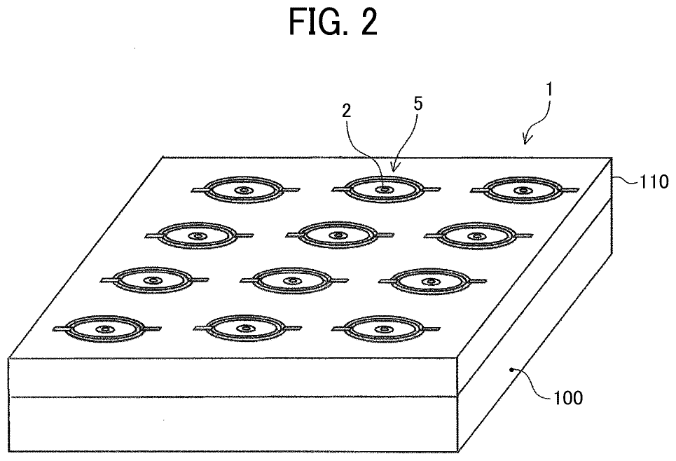

FIG. 1 is a cross-sectional view schematically illustrating the head 1 of the nozzle vibration type in the present embodiment, and FIG. 2 is a perspective view schematically illustrating the head 1.

The head 1 includes an actuator 110, a diaphragm 103, a channel substrate 100, and a frame 120.

The actuator 110 has a thin film shape and includes a plurality of nozzles 2 that discharges a liquid, and a piezoelectric element 5 as an annular electromechanical conversion element arranged around the nozzle 2. The channel substrate 100 includes a plurality of pressure chambers 4 (also referred to as individual chambers) communicating with the plurality of nozzles 2, respectively. The frame 120 includes a common chamber 3 communicating with the plurality of pressure chambers 4.

Electrical connection pads 6 for connecting to electrical parts such as an external power supply are provided on both ends of the head 1.

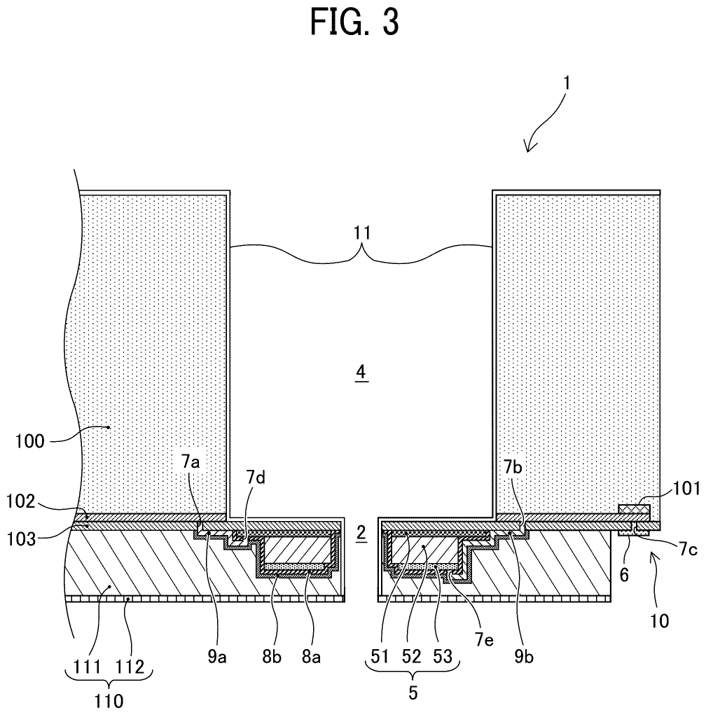

FIG. 3 is an enlarged cross-sectional view of a portion X in FIG. 1.

The channel substrate 100 is a silicon on insulator (SOI) substrate, and includes a drive circuit 101 and a wiring 102 on a side on which the diaphragm 103 is formed. The drive circuit 101 is a circuit including a transistor and a resistor. The wiring 102 includes wiring for applying a bias to a first electrode 51, and wiring for applying a bias to a second electrode 53. The wiring 102 is electrically connected to the electrical connection pad 6 via a third contact 7c opened on the diaphragm 103.

The actuator 110 includes a nozzle forming portion 111 (film), in which a plurality of nozzles 2 is formed, that covers the piezoelectric element 5, and a liquid repellent film 112 is formed on a nozzle surface of the nozzle forming portion 111. When a liquid is continuously discharged, mist generated at the same time as the discharge adheres to the nozzle surface. When a large amount of the mist adheres to the nozzle surface, there is a possibility that the liquid discharged from the nozzle 2 is affected by the liquid adhered to the nozzle surface and deviates from a desired landing position. Formation of the liquid repellent film 112 on the nozzle surface may suppress adhesion of the liquid to the nozzle surface, and suppress an influence of the liquid adhered to the nozzle surface on the liquid discharged from the nozzle 2.

The piezoelectric element 5 of the actuator 110 includes the first electrode 51 (also referred to as a lower electrode), a piezoelectric film 52, and the second electrode 53 (also referred to as an upper electrode). The piezoelectric element 5 is covered with a first insulating film 8a.

On the first insulating film 8a, a hole-shaped fourth contact 7d for electrically connecting to the first electrode 51 and a hole-shaped fifth contact 7e for electrically connecting to the second electrode 53 are formed. On the first insulating film 8a, first lead-out wiring 9a that electrically connects the first electrode of the piezoelectric element and the wiring 102 of the channel substrate 100, and second lead-out wiring 9b that electrically connects the second electrode 53 of the piezoelectric element and the wiring 102 of the channel substrate 100 are formed.

The first lead-out wiring 9a is electrically connected to the first electrode 51 via the fourth contact 7d, and electrically connected to the wiring 102 via the first contact 7a. The second lead-out wiring 9b is electrically connected to the second electrode 53 via the fifth contact 7e, and electrically connected to the wiring 102 via the second contact 7b.

The first lead-out wiring 9a and the second lead-out wiring 9b are covered with a second insulating film 8b. In the present embodiment, the second insulating film 8b also covers the piezoelectric element 5, and has a function of preventing moisture entering the nozzle forming portion 111 made of resin from entering the piezoelectric element 5 to protect the piezoelectric element 5.

It is possible to provide lead-out wiring on each of the first electrode 51 and the second electrode 53 to electrically connect to the wiring 102 directly via a contact opened on the diaphragm.

An adhesion improving film for securing adhesion to the nozzle forming portion 111 may be formed on the second insulating film 8b.

A liquid that fills the head 1 enters the nozzle 2 and forms a meniscus in the nozzle. When applying a predetermined drive waveform (voltage) to each electrode of the piezoelectric element 5, the piezoelectric film 52 vibrates, and the diaphragm 103 vibrates in a vertical direction in the drawing. When the diaphragm 103 vibrates, a pressure change occurs in the liquid in the pressure chamber, and the liquid is discharged from the nozzle 2.

In the head 1 of the present embodiment, a protective film 11 as a surface layer lyophilic with the liquid discharged by the head 1 that prevents erosion by the liquid is formed on an inner peripheral surface of the nozzle 2, an inner peripheral surface of the pressure chamber 4, and a bottom surface of the common chamber 3.

In the present embodiment, the liquid discharged by the head 1 is alkaline, and as described later, the channel substrate 100 and the diaphragm 103 forming the pressure chamber 4 are made of silicon single crystal and silicon oxide. These materials are vulnerable to an alkaline liquid, and elute and erode into an alkaline solution. In order to prevent this, a liquid-resistant protective film 11 that prevents erosion by the liquid is formed to protect the channel substrate 100 and the diaphragm 103 from the liquid.

As described later, the pressure chamber 4 and the nozzle 2 are formed by dry etching. Since a dry etching gas contains fluorine, a surface film containing fluorine is formed on the inner wall surface of the pressure chamber 4 and the inner peripheral surface of the nozzle 2 after the etching, and the inner wall surface of the pressure chamber 4 and the inner peripheral surface of the nozzle have liquid repellency. When the inner peripheral surface of the pressure chamber 4 has liquid repellency, a liquid does not spread in a wet manner on the inner peripheral surface of the pressure chamber 4 at the time of filling with the liquid, so that the pressure chamber 4 is not satisfactorily filled with the liquid, and bubbles might be generated at corners of the pressure chamber 4.

In the general unimorph piezo head, by filling the pressure chamber 4 while pressurizing the same by a pump, or by filling the same while covering the nozzle 2 with a suction cap and sucking the liquid from the nozzle 2, air in the pressure chamber 4 is actively ejected from the nozzle 2. This secures a satisfactory filling property. However, in the nozzle vibration type, the diaphragm 103 is a thin film, so that when filling while pressurizing and sucking, a crack might occur on the diaphragm 103.

In contrast, in the present embodiment, since the protective film 11 is lyophilic and is formed on the inner peripheral surface of the pressure chamber 4 and the inner peripheral surface of the nozzle 2, a surface tension of the liquid to the inner peripheral surfaces of the pressure chamber 4 and the nozzle 2 may be reduced. A lyophilicity of the protective film 11 with a liquid may be larger than a lyophilicity of a film formation surface (a lower layer surface of the protective film 11) of the pressure chamber 4 or the nozzle 2 on which the protective film 11 is formed. When a liquid solvent is aqueous, a highly hydrophilic protective film is used, and when the liquid solvent is oily, a highly oleophilic protective film is used, so that a highly lyophilic protective film 11 can be formed.

In this manner, by forming the protective film 11 having lyophilicity with respect to the liquid that fills the pressure chamber 4 on the inner peripheral surfaces of the nozzle 2 and the pressure chamber 4, the liquid easily spreads in a wet manner on the inner peripheral surfaces of the pressure chamber 4 and the nozzle 2 at the time of filling with the liquid. As a result, a filling property of the liquid may be improved, and the pressure chamber 4 and the nozzle 2 may be satisfactorily filled with the liquid without pressurizing or sucking at the time of filling with the liquid. Therefore, it is possible to suppress the occurrence of crack on the diaphragm 103 at the time of filling with the liquid.

Since the liquid solvent of the present embodiment is aqueous, formation of the protective film 11 not containing at least fluorine on the inner peripheral surfaces of the pressure chamber 4 and the nozzle 2 may improve lyophilicity as compared with that of the surface film containing fluorine formed by the dry etching. In addition to the above, since this film is in direct contact with various liquids, it is desirable to use a material having liquid resistance, for example, an oxide of metal forming a nonconductor. As a method for further improving lyophilicity, a mixture of silicon dioxide (SiO₂) with the metal oxide forming the nonconductor at a molecular level may also be used. SiO₂ of the protective film 11 has a hydrophilic OH group in which O on a surface thereof is substituted. Therefore, hydrophilicity may be further imparted to the protective film 11. Examples of the metal of the metal oxide include tantalum (Ta), niobium (Nb), titanium (Ti), zirconium (Zr), hafnium (Hf), and tungsten (W) having high correspondence to an oxidation number. In particular, Zr or Hf having a valence similar to that of SiO₂, or Ta having a valence before or after that is desirable.

For example, the protective film 11 may have a two-layer structure of a liquid-resistant film and a lyophilic film. In this case, after forming the liquid-resistant film on the inner peripheral surfaces of the nozzle 2 and the pressure chamber 4, the lyophilic film is formed on the liquid-resistant film.

In the present embodiment, the protective film 11 (lyophilic protective film) is formed also on the surface opposite to the surface on which the diaphragm 103 is formed of the channel substrate 100 forming the bottom surface of the common chamber. It is possible that the protective film 11 on this surface has only liquid resistance. However, a step of forming the protective film on the bottom surface of the common chamber should be provided separately from a step of forming the lyophilic protective film on the inner peripheral surface of the nozzle and the wall surface of the pressure chamber, which might increase the number of manufacturing steps. By forming the protective film 11 on the bottom surface of the common chamber 3, the liquid easily spreads in a wet manner on the bottom surface of the common chamber 3, so that the filling property of the liquid is also improved. Therefore, it is preferable to form the protective film 11 (lyophilic protective film) also on the surface opposite to the surface on which the diaphragm 103 is formed of the channel substrate 100 forming the bottom surface of the common chamber 3.

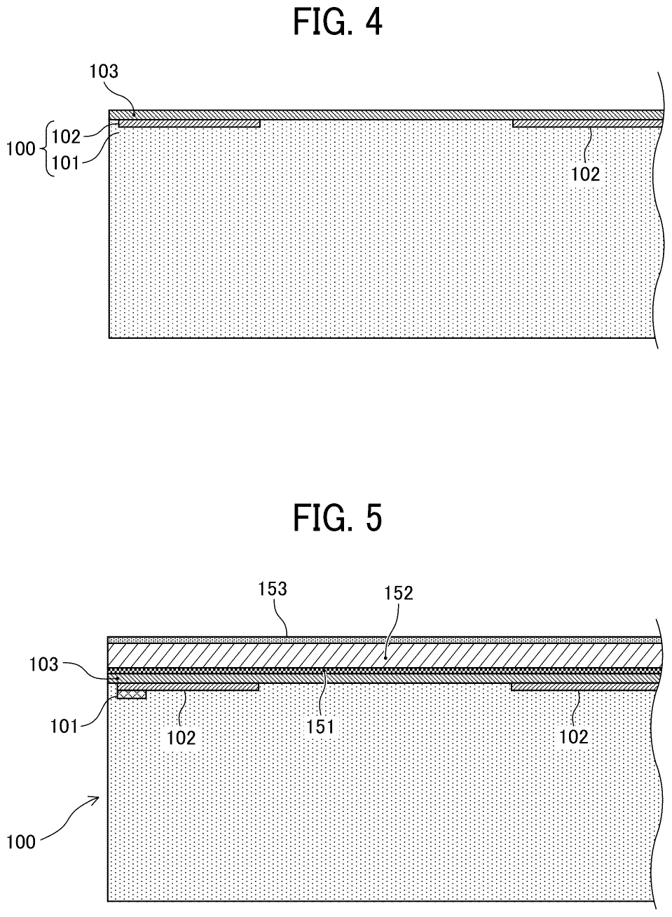

Next, a method for manufacturing the head 1 of the present embodiment will be described. FIGS. 4 to 15 are cross-sectional views illustrating a cross section orthogonal to an arranged direction of the nozzles 2 for explaining manufacturing steps of the head 1 of the present embodiment.

As illustrated in FIG. 4, the drive circuit 101 including the transistor and the resistor, and the wiring 102 are formed on a silicon film of the channel substrate 100 as the silicon on insulator (SOI) substrate. When the drive circuit 101 is not incorporated in the channel substrate 100, an SI substrate may be used as the channel substrate 100.

Next, the diaphragm 103 is formed on the surface on which the drive circuit 101 and the wiring 102 are formed of the channel substrate 100. It is sufficient that the diaphragm 103 is made of a material at least having an insulating property such as SiO₂, SiN, a metal oxide, and a resin. However, in order to increase displacement, a material having a low Young's modulus is desirable, and considering a difference in linear expansion coefficient from the channel substrate 100, SiO₂ (silicon dioxide) having a relatively small difference is most desirable as the material of the diaphragm 103.

Next, as illustrated in FIG. 5, the first electrode layer 151, the piezoelectric layer 152, and the second electrode layer 153 are formed on the diaphragm 103. The first electrode layer 151 and the second electrode layer 153 are desirably made of metal having low electric resistance and low reactivity, and are desirably made of metal such as Ir or Mo.

As the piezoelectric material forming the piezoelectric layer 152, when the drive circuit 101 and the wiring 102 are incorporated in the channel substrate 100 to improve the density as in the present embodiment, the piezoelectric material having film formation temperature of 450° C. or lower is desirable in order not to break them. Examples of the piezoelectric materials having the film formation temperature of 450° C. or lower include AlN.

By using AlN as the piezoelectric material, the following advantages may also be obtained. That is, it is possible to align a crystal orientation of the piezoelectric film 52 to improve the piezoelectric characteristic, but in order to control the orientation, an orientation control layer should be provided between the diaphragm 103 and the first electrode 51. When the piezoelectric material of the piezoelectric film 52 is AlN, by using AlN also as the orientation control layer, a lattice constant of the first electrode 51 made of Mo may be made closer to that of AlN. As a result, the crystal orientation of the piezoelectric film 52 is aligned, and the piezoelectric characteristic may be improved.

The first electrode layer 151 and the second electrode layer 153 are generally formed by a sputtering method. A sputtering method and a sol-gel method may be used when forming the piezoelectric layer 152, but the latter is not suitable for forming the channel substrate 100 including the drive circuit 101 and the wiring 102 because of its high film formation temperature. Therefore, the piezoelectric layer 152 is also desirably formed using the sputtering method.

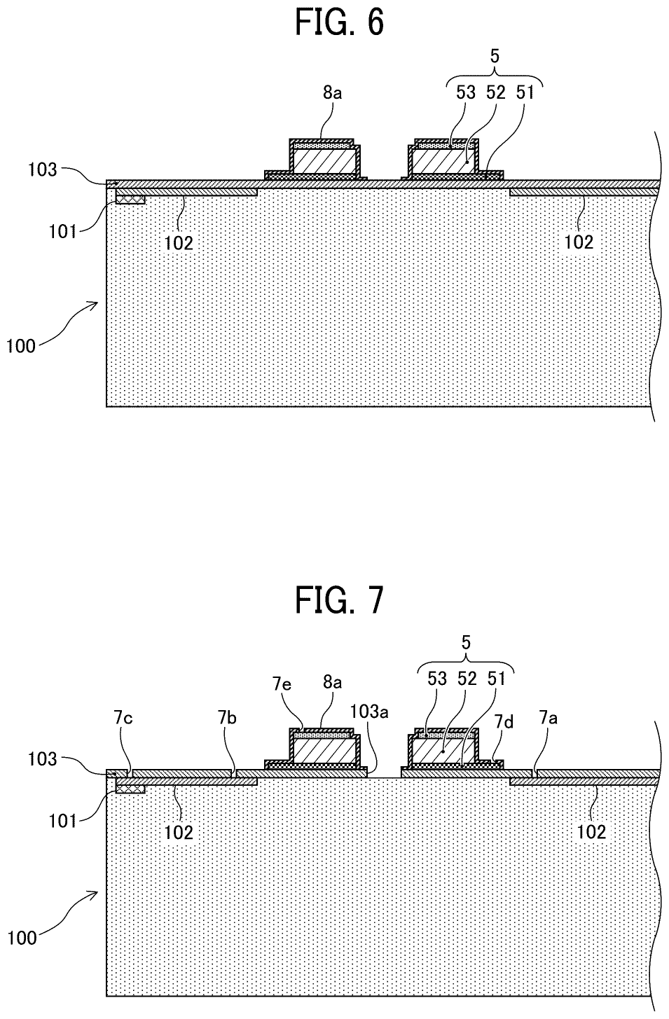

After the first electrode layer 151, the piezoelectric layer 152, and the second electrode layer 153 are formed, as illustrated in FIG. 6, they are shaped into appropriate shapes to obtain the piezoelectric element 5 including the first electrode 51, the piezoelectric film 52, and the second electrode 53. By processing the first electrode layer 151, the piezoelectric layer 152, and the second electrode layer 153 by photolithography and etching, it is possible to easily obtain the first electrode 51, the piezoelectric film 52, and the second electrode 53 having desired shapes. The etching includes wet etching and dry etching, and the latter is preferable because corrosion of the first electrode 51, the second electrode 53, and the piezoelectric film 52 may be reduced. Since residues due to the processing tend to remain after the dry etching, a cleaning step may be performed after shaping for removing the residues.

After the first electrode 51, the piezoelectric film 52, and the second electrode 53 are shaped, the first insulating film 8a is formed by film formation and etching as illustrated in FIG. 6. The first insulating film 8a desirably has an insulating property similar to that of the diaphragm 103, has a small Young's modulus, and has a linear expansion coefficient close to that of a component, so that it is preferable to use SiO₂ the same as that of the diaphragm 103.

After the first insulating film 8a is formed, as illustrated in FIG. 7, hole-shaped first to fifth contacts 7a to 7e are formed on the diaphragm 103 and the first insulating film 8a by photolithography and etching. On the diaphragm 103, the first to third contacts 7a to 7c are formed, and a nozzle forming hole 103a for forming the nozzle 2 is formed. It is preferable that the nozzle forming hole 103a is processed simultaneously with the first to third contacts 7a to 7c because subsequent processing may be easily performed.

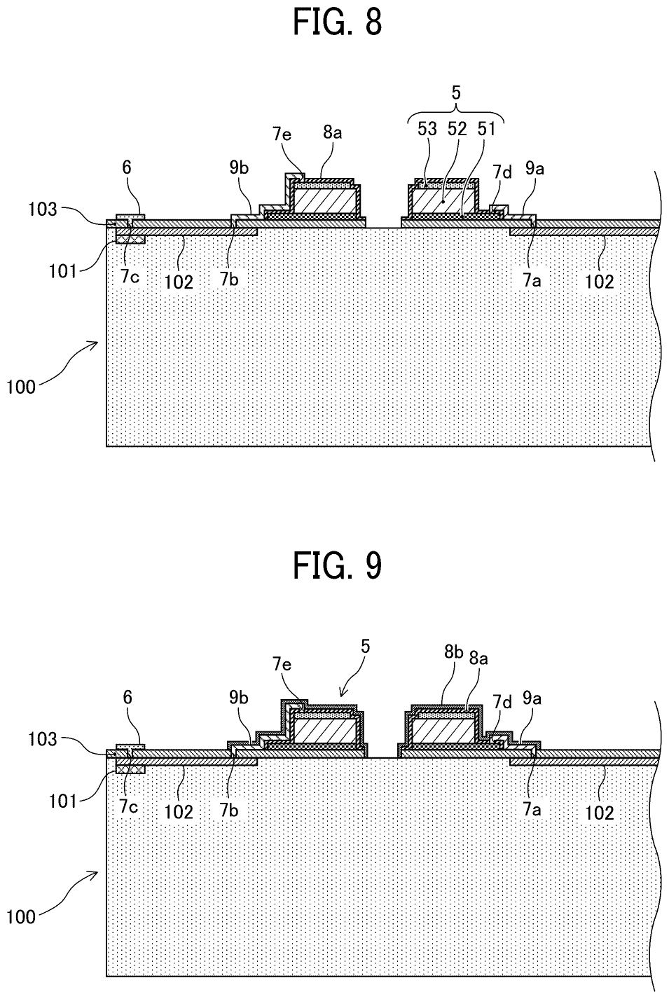

Next, as illustrated in FIG. 8, the first lead-out wiring 9a, the second lead-out wiring 9b, and the electrical connection pad 6 are formed. A material of each of the first lead-out wiring 9a, the second lead-out wiring 9b, and the electrical connection pad 6 is generally Al or an AlCu alloy. At this step, the first lead-out wiring 9a is electrically connected to the first electrode 51 via the fourth contact 7d and is electrically connected to the wiring 102 via the first contact 7a. The second lead-out wiring 9b is electrically connected to the second electrode 53 via the fifth contact 7e and is electrically connected to the wiring 102 via the second contact 7b. The electrical connection pad 6 is electrically connected via the third contact 7c.

Next, as illustrated in FIG. 9, the second insulating film 8b is formed so as to cover the first lead-out wiring 9a, the second lead-out wiring 9b, and the piezoelectric element 5. For the second insulating film 8b also, SiO₂ may be used similarly as in the first insulating film 8a, but it is desirable to use SiN widely used as a protective film of semiconductor in order to improve reliability with respect to humidity. Since the second insulating film 8b has two functions of insulating property and moisture proof property, the actuator 110 may be made thinner than that when a moisture proof protective film is formed on the second insulating film 8b. Consequently, the diaphragm 103 is easily deformed, and vibration efficiency may be enhanced.

By the above steps, the piezoelectric element 5 may be driven.

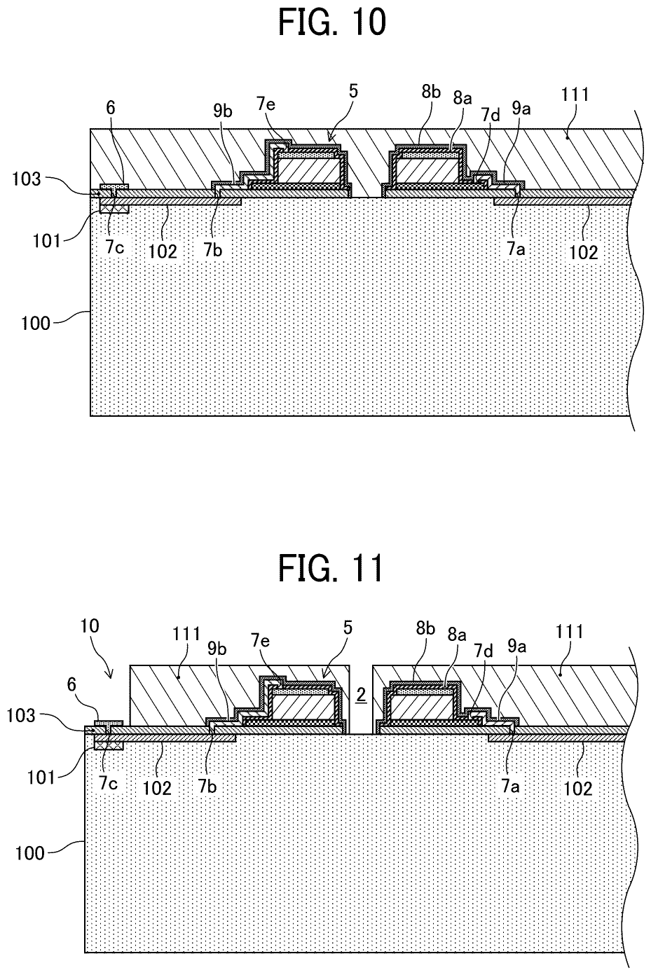

Next, as illustrated in FIG. 10, the nozzle forming portion 111 for forming the nozzle is formed. The nozzle forming portion 111 is formed by spin coating. As a material of the nozzle forming portion 111, a resin that may be applied by spin coating is desirably used, and from a viewpoint of chemical resistance, SU8 and BCB are desirably used. Next, as illustrated in FIG. 11, the nozzle 2 and a pad opening 10 are formed by etching. The etching of the nozzle 2 and the pad opening 10 is dry etching.

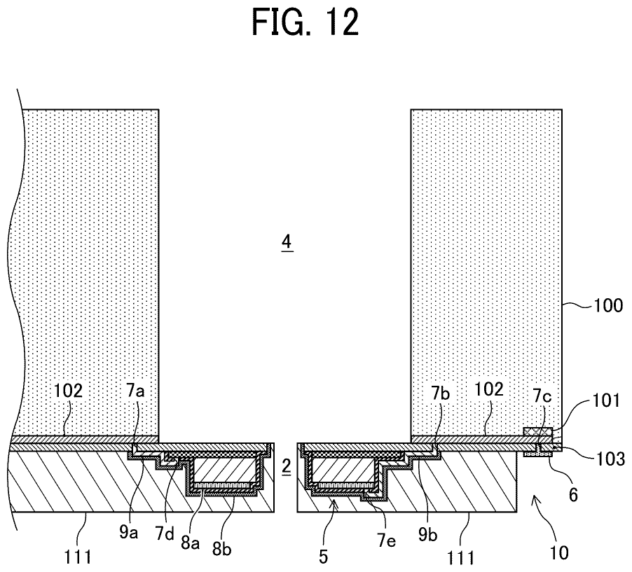

Next, as illustrated in FIG. 12, the channel substrate 100 is processed by Si etching to form a plurality of pressure chambers 4 having a circular hole shape. In the pressure chamber 4, an aspect ratio of the cross section should be made high (a depth of the liquid chamber should be made larger than a diameter of the liquid chamber) in order to improve discharge efficiency and reduce crosstalk. Therefore, in the present embodiment, the pressure chamber 4 is formed by deep reactive ion etching (DRIE). In this DRIE, a CF-based gas such as CF4 and C4F8 or an SF-based gas such as SF6 is used as an etching gas.

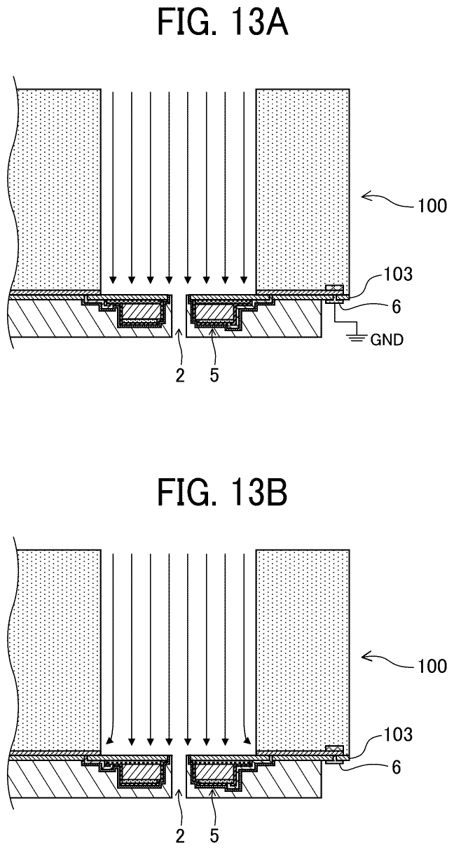

FIG. 13A is a view for explaining formation of the pressure chamber in the present embodiment, and FIG. 13B is a view for explaining formation of a conventional pressure chamber.

As illustrated in FIG. 13A, in the present embodiment, the electrical connection pad 6 is brought into conduction with the ground to form the pressure chamber 4.

DRIE is ion etching, and in the conventional example illustrated in FIG. 13B, as etching progresses (=deepens), an etching surface is charged up, and an electric field in the vicinity of an etching region is disturbed. As a result, as indicated by an arrow in FIG. 13B, ions are bent due to disturbance of the electric field in the vicinity of the etching region, and there is a possibility that so-called notching in which an end on a diaphragm side of a side wall of the pressure chamber 4 is excessively scraped, and bowing in which the wall surface of the pressure chamber 4 is curved in a bow shape occur. Therefore, in the conventional example illustrated in FIG. 13B, the pressure chamber 4 may not be accurately shaped, and there is a possibility that a desired discharge characteristic may not be obtained.

Therefore, as illustrated in FIG. 13A, it is preferable to bring the electrical connection pad 6 into conduction with the ground to form the pressure chamber 4. As a result, the charge-up of the etching surface of the channel substrate 100 is suppressed, and the disturbance of the electric field in the vicinity of the etching region may be suppressed. As a result, bending of the released ions may be suppressed, occurrence of the notching and bowing may be suppressed, the pressure chamber 4 may be accurately shaped, and the desired discharge characteristic may be obtained.

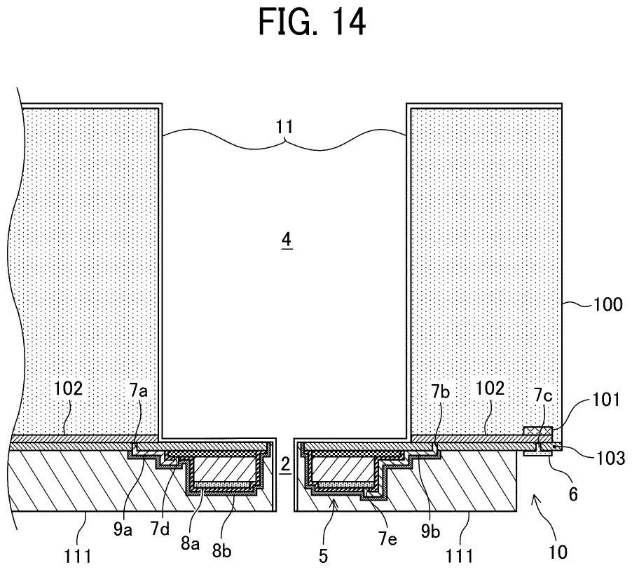

After the pressure chamber 4 is formed, as illustrated in FIG. 14, the protective film 11 is formed on the inner peripheral surfaces of the pressure chamber 4 and the nozzle, and on a back surface (opposite to the side on which the diaphragm is formed) of the substrate that serves as the bottom surface of the common chamber 3. A protector such as a masking tape is adhered to the surface of the nozzle forming portion 111 (nozzle surface), and then the protective film 11 is formed. There is no problem even if the protective film 11 is adhered to the surface of the nozzle forming portion 111. Attention should be paid so that the protective film 11 does not adhere to the pad opening 10. Therefore, it is possible to close only the pad opening 10 with the masking tape. The protective film 11 adhered to the pad opening 10 may be removed by etching after the protective film is formed. Alternatively, the pad opening 10 may be formed again by photolithography and etching after the protective film is formed.

As a method for forming the protective film 11, there are physical vapor deposition and chemical vapor deposition. It is desirable to use chemical vapor deposition from the viewpoint of excellent film forming property for a structure having a step. By using the chemical vapor deposition as the method for forming the protective film 11, the protective film 11 may be satisfactorily formed on the inner peripheral surfaces of the pressure chamber 4 and the nozzle 2 and the back surface of the substrate serving as the bottom surface of the common chamber 3.

CVD or ALD may be exemplified as the method for forming the protective film 11 while mixing the metal oxide with SiO₂ at an atomic level. The latter ALD is desirable because a material may be deposited for each atomic layer, so that a densely mixed film may be formed.

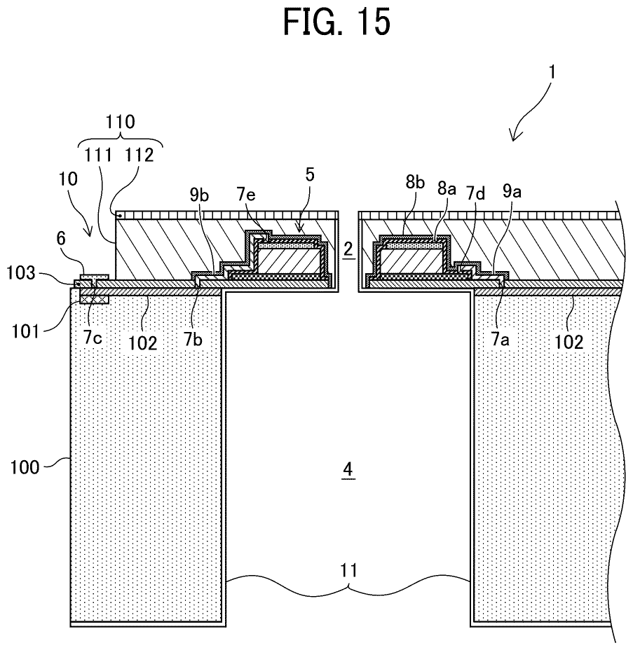

Next, as illustrated in FIG. 15, the liquid repellent film 112 is formed on the nozzle surface of the nozzle forming portion 111. As a material of the liquid repellent film 112, perfluorodecyltrichlorosilane or perfluorooctyltrichlorosilane may be used, and a film may be formed by vapor deposition. Since the former is regulated by the Stockholm Convention, it is desirable to use the latter.

For the purpose of improving adhesion between the liquid repellent film 112 and the nozzle forming portion 111, the liquid repellent film 112 may be formed after an adhesion layer is formed on the nozzle surface of the nozzle forming portion 111. When perfluorooctyltrichlorosilane is used as the liquid repellent film 112, a single film of SiO₂ or a hydrophilic protective film 11 formed on the inner wall surface of the pressure chamber 4 or the inner peripheral surface of the nozzle may be used as the adhesion layer. When a functional group of the adhesion layer forms a siloxane bond between Si and the liquid repellent film 112, adhesion of the liquid repellent film 112 may be enhanced.

In either method for applying the liquid repellent film 112 by vapor deposition or by droplet application, if a water repellent material adheres onto the protective film 11, lyophilicity is lost. Therefore, it is preferable to provide a step of removing a water repellant agent adhered to the protective film 11. Since the adhered water repellent agent is basically an organic substance, this may be easily removed by oxygen plasma. At that time, the nozzle surface is protected with a masking tape so that the liquid repellent film 112 on the nozzle surface is not lost due to creeping of the plasma to a back surface.

Thereafter, the frame 120 in which the common chamber 3 is formed is joined on the back surface of the channel substrate 100 and the head 1 is formed.

In the nozzle vibration type liquid discharge head, since positional accuracy between the actuator 110 including the nozzle and the channel substrate 100 significantly affects the discharge characteristic, manufacturing should be performed with high dimensional accuracy. Therefore, when the actuator 110 including the nozzle is joined to the channel substrate 100 including the pressure chamber 4 to form the head 1, a highly accurate joining step should be performed. In contrast, in the present embodiment, a material forming the actuator 110 is sequentially formed on the channel substrate 100 and predetermined processing is performed thereon, then the actuator 110 is formed directly on the channel substrate 100. This eliminates the need for the highly accurate joining step, and the head 1 may be easily formed.

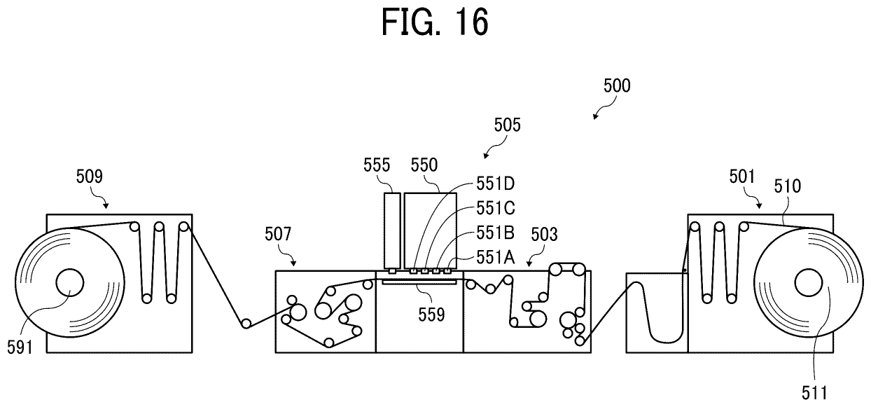

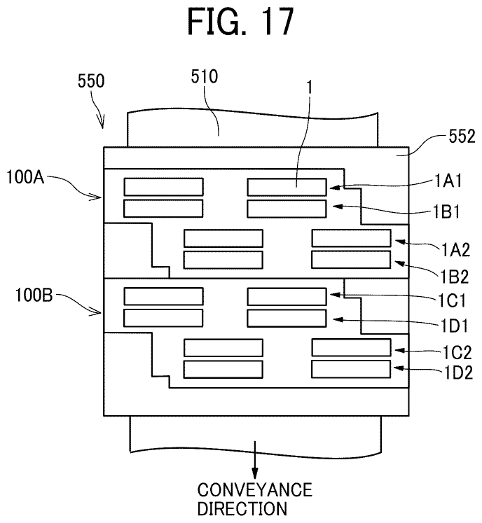

Next, an example of the liquid discharge apparatus according to the present embodiment will be described with reference to FIGS. 16 and 17.

FIG. 16 is a schematic explanatory diagram of a printer that is an inkjet recording apparatus as a liquid discharge apparatus in the present embodiment.

FIG. 17 is an explanatory plan view of an example of a head device of the printer of the present embodiment.

A printer 500, which is the liquid discharge apparatus, includes a feeder 501 that feeds a continuous medium 510, and a guide conveyor 503 that guides and conveys the continuous medium 510 fed from the feeder 501 to the printing unit 505. The printer 500 also includes the printing unit 505 that performs printing to discharge a liquid onto the continuous medium 510 and form an image, a dryer 507 that dries the continuous medium 510, and an ejector 509 that ejects the continuous medium 510.

The continuous medium 510 is fed from a winding roller 511 of the feeder 501, guided and conveyed with rollers of the feeder 501, the guide conveyor 503, the dryer 507, and the ejector 509, and wound around a take-up roller 591 of the ejector 509. In the printing unit 505, the continuous medium 510 is conveyed opposite a head device 550 on a conveyance guide 559. The head device 550 discharges a liquid from the nozzles 2 of the heads 1 to form an image on the continuous medium 510.

In the printer 500 of the present embodiment, the head device 550 includes two head modules 100A and 100B according to the present embodiment described above in a common base 552.

When an arranged direction of the heads 1 in a direction orthogonal to a conveyance direction of the head modules 100A and 100B is defined as a head arranging direction, a liquid of the same color is discharged by head arrays 1A1 and 1A2 of the head module 100A. Similarly, head arrays 1B1 and 1B2 of the head module 100A are grouped as one set that discharge a liquid of the same desired color. Head arrays 1C1 and 1C2 of the head module 100B are grouped as one set that discharge a liquid of the same desired color. Head arrays 1D1 and 1D2 of the head module 100B are grouped as one set to discharge a liquid of the same desired color.

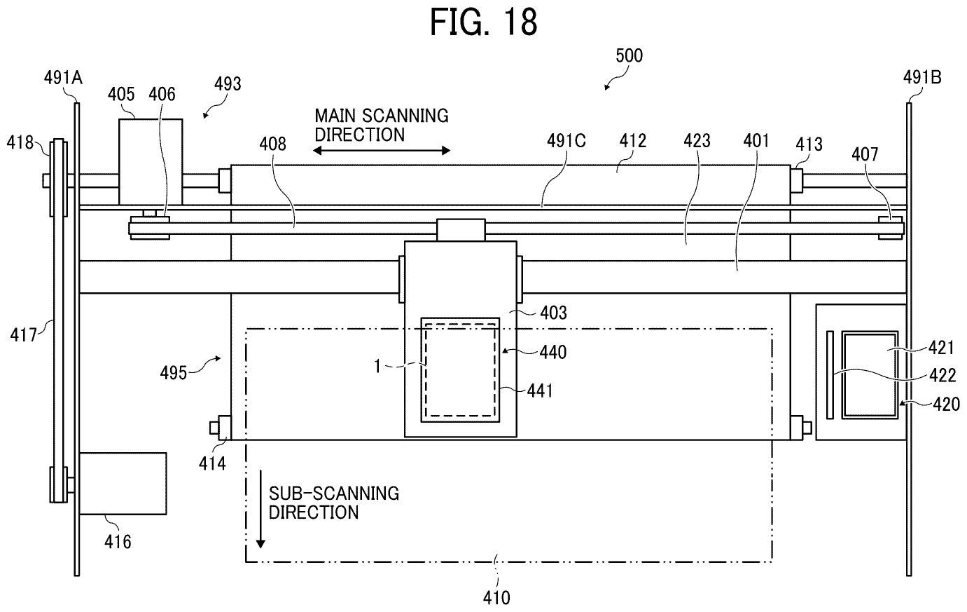

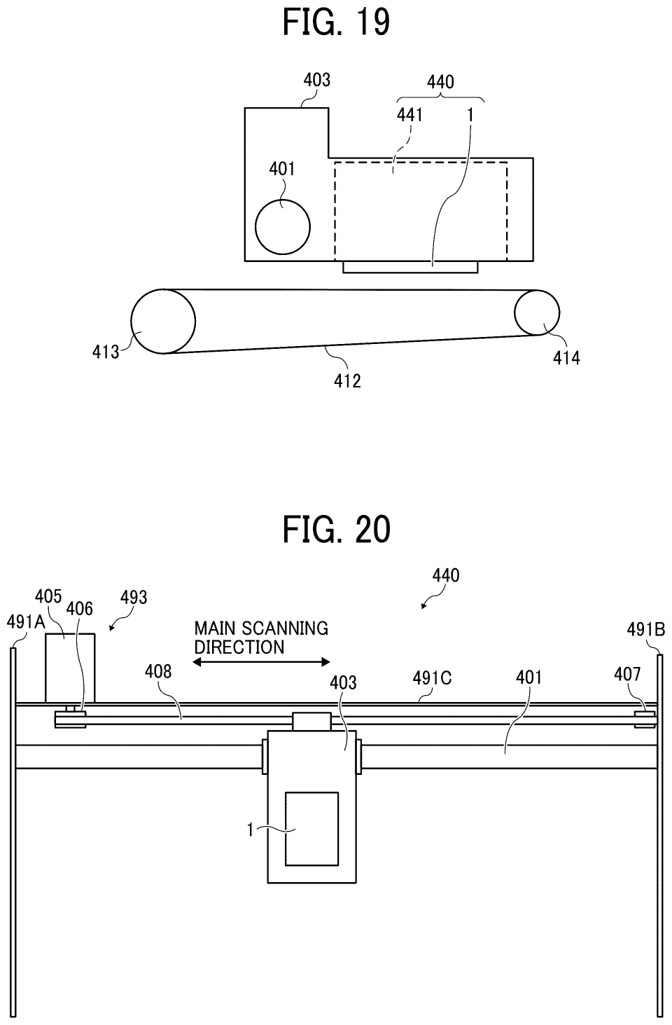

Next, another example of the printer as the liquid discharge apparatus according to the present embodiment will be described with reference to FIGS. 18 and 19.

FIG. 18 is an explanatory plan view of a substantial part of the printer of this example.

FIG. 19 is an explanatory plan view of a substantial part of the printer of this example.

The printer 500 of this example is a serial head apparatus, and a carriage 403 reciprocally moves in a main scanning direction by a main scan moving unit 493. The main scan moving unit 493 includes a guide 401, a main scan motor 405, a timing belt 408, and the like. The guide 401 is bridged between a left-side plate 491A and a right-side plate 491B to moveably hold the carriage 403. The main scan motor 405 reciprocally moves the carriage 403 in the main scanning direction MSD via the timing belt 408 bridged between a drive pulley 406 and a driven pulley 407.

A liquid discharge device 440 in which the head 1 according to the present embodiment and a head tank 441 are integrated is mounted on the carriage 403. The head 1 discharges liquids of respective colors of yellow (Y), cyan (C), magenta (M), and black (K), for example. The head 1 includes a nozzle array including a plurality of nozzles 2 arrayed in a sub scanning direction as indicated by arrow “SSD”. The sub scanning direction is orthogonal to the main scanning direction MSD. The head 1 is mounted to the carriage 403 so that ink droplets are discharged downward. The head 1 is coupled with a liquid circulation apparatus, and a liquid of a desired color is circulated and supplied.

The printer 500 includes a conveyor 495 to convey a sheet 410. The conveyor 495 includes a conveyance belt 412 as a conveyor and a sub scan motor 416 to drive the conveyance belt 412. The conveyance belt 412 attracts the sheet 410 and conveys the sheet 410 to a position facing the head 1. The conveyance belt 412 is an endless belt stretched between a conveyance roller 413 and a tension roller 414. Attraction of the sheet 410 to the conveyance belt 412 may be applied by electrostatic attraction, air suction, or the like. The conveyance belt 412 rotates in the sub scanning direction SSD as the conveyance roller 413 is rotationally driven by the sub scan motor 416 via a timing belt 417 and a timing pulley 418.

At one side in the main scanning direction MSD of the carriage 403, a maintenance unit 420 to maintain the head 1 in good condition is disposed on a lateral side of the conveyance belt 412. The maintenance unit 420 includes, for example, a cap 421 for capping the nozzle surface of the head 1, and a wiper 422 for wiping the nozzle surface. The main scan moving unit 493, the maintenance unit 420, and the conveyor 495 are attached to a housing including the left-side plate 491A, the right-side plate 491B, and a back plate 491C.

In the printer 500 configured in this manner, the sheet 410 is fed onto the conveyance belt 412 to be attracted, and the sheet 410 is conveyed in the sub scanning direction by the rotation of the conveyance belt 412. The head 1 is driven in response to image signals while the carriage 403 moves in the main scanning direction MSD, to discharge a liquid to the sheet 410 stopped, thus forming an image on the sheet 410.

Next, another example of the liquid discharge device according to the present embodiment will be described with reference to FIG. 20.

FIG. 20 is an explanatory plan view of a substantial part of the liquid discharge device according to this example.

The liquid discharge device 440 includes a housing including the left-side plate 491A, the right-side plate 491B, and the back plate 491C, the main scan moving unit 493, the carriage 403, and the head 1 among members forming the liquid discharge apparatus.

Note that, in the liquid discharge device 440, the maintenance unit 420 described above may be mounted on the right-side plate 491B, for example.

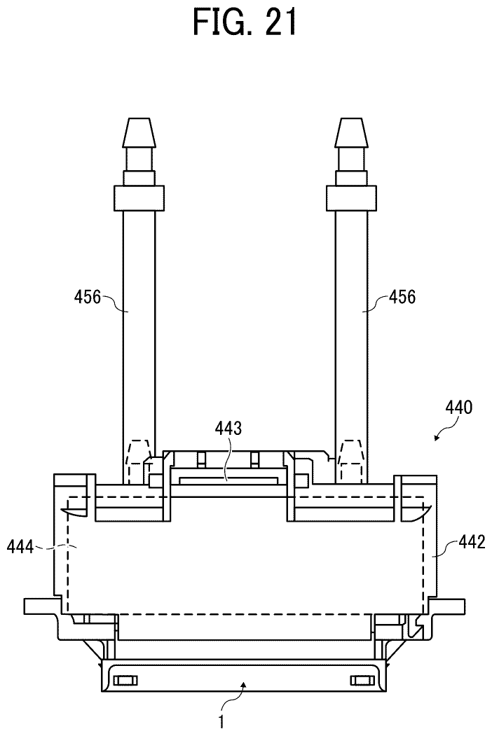

Next, still another example of the liquid discharge device according to the present embodiment will be described with reference to FIG. 21.

FIG. 21 is an explanatory front view of the liquid discharge device according to this example.

The liquid discharge device 440 includes the head 1 to which a channel part 444 is attached, and a tube 456 connected to the channel part 444.

Further, the channel part 444 is disposed inside a cover 442. Instead of the channel part 444, the liquid discharge device 440 may include the head tank 441. A connector 443 electrically connected with the head 1 is provided on an upper part of the channel part 444.

In the present embodiment, a discharged liquid is not limited to a particular liquid as long as the liquid has a viscosity or surface tension to be discharged from a head 1 (liquid discharge head). However, preferably, the viscosity of the liquid is not greater than 30 mPa·s under ordinary temperature and ordinary pressure or by heating or cooling. Examples of the liquid include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as DNA, amino acid, protein, or calcium, or an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

Examples of an energy source to generate energy to discharge a liquid include a piezoelectric actuator (a laminated piezoelectric element or a thin-film piezoelectric element), a thermal actuator that employs a thermoelectric conversion element, such as a heating resistor, and an electrostatic actuator including a diaphragm and opposed electrodes.

The “liquid discharge device” is an assembly of parts relating to liquid discharge. The term “liquid discharge device” represents a structure including the head and a functional part(s) or unit(s) combined to the head to form a single unit. For example, the “liquid discharge device” includes a combination of the head with at least one of a head tank, a carriage, a supply unit, a maintenance unit, a main scan moving unit, and a liquid circulation apparatus.

Examples of the “single unit” include a combination in which the head and one or more functional parts and units are secured to each other through, e.g., fastening, bonding, or engaging, and a combination in which one of the head and the functional parts and units is movably held by another. The head may be detachably attached to the functional part(s) or unit(s) each other.

For example, the head and the head tank may form the liquid discharge device as a single unit. Alternatively, the head and the head tank coupled (connected) with a tube or the like may form the liquid discharge device as a single unit. A unit including a filter may be added at a position between the head tank and the head of the liquid discharge device.

In another example, the head and the carriage may form the liquid discharge device as a single unit.

In still another example, the liquid discharge device includes the head movably held by a guide that forms part of a main scan moving unit, so that the head and the main scan moving unit form a single unit. The liquid discharge device may include the head, the carriage, and the main scan moving unit that form a single unit.

In still another example, a cap that forms a part of the maintenance unit may be secured to the carriage mounting the head so that the head, the carriage, and the maintenance unit form a single unit to form the liquid discharge device.

Further, in still another example, the liquid discharge device includes tube connected to the head mounting the head tank or the channel part so that the head and the supply unit form a single unit. A liquid in a liquid reservoir source such as an ink cartridge is supplied to the head through this tube.

The main scan moving unit may be a guide only. The supply unit may be a tube(s) only or a loading unit only.

The combination with the head 1 is herein described as the “liquid discharge device”. The “liquid discharge device” includes a head module including the above-described head, and a head device in which the above-described functional parts and units are combined to form a single unit.

The term “liquid discharge apparatus” used herein also represents an apparatus including the head, the liquid discharge device, the head module, the head device, the apparatus that discharges a liquid by driving the head. The liquid discharge apparatus may be, for example, an apparatus capable of discharging a liquid to a material to which liquid can adhere or an apparatus to discharge liquid toward gas or into liquid.

The “liquid discharge apparatus” may include units to feed, convey, and eject the material on which liquid can adhere. The liquid discharge apparatus may further include a pretreatment apparatus to coat a treatment liquid onto the material, and a post-treatment apparatus to coat a treatment liquid onto the material, onto which the liquid has been discharged.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers to form a three-dimensional fabrication object.

The “liquid discharge apparatus” is not limited to an apparatus to discharge liquid to visualize meaningful images, such as letters or figures. For example, the liquid discharge apparatus may be an apparatus to form arbitrary images, such as arbitrary patterns, or fabricate three-dimensional images.

The above-described term “material onto which liquid can adhere” represents a material on which liquid is at least temporarily adhered, a material on which liquid is adhered and fixed, or a material into which liquid is adhered to permeate. Examples of the “material on which liquid can adhere” include recording media, such as paper sheet, recording paper, recording sheet of paper, film, and cloth, electronic component, such as electronic substrate and piezoelectric element, and media, such as powder layer, organ model, and testing cell. The “material on which liquid can adhere” includes any material on which liquid can adhere, unless particularly limited.

Examples of the “material onto which liquid can adhere” include any materials on which liquid can adhere even temporarily, such as paper, thread, fiber, fabric, leather, metal, plastic, glass, wood, and ceramic.

The “liquid discharge apparatus” may be an apparatus to relatively move the head and a material on which liquid can adhere. However, the liquid discharge apparatus is not limited to such an apparatus. For example, the liquid discharge apparatus may be a serial head apparatus that moves the head or a line head apparatus that does not move the head.

Another example of the “liquid discharge apparatus” is a treatment liquid application apparatus that discharges a treatment liquid onto a sheet in order to apply the treatment liquid to the surface of the sheet for the purpose of modifying the surface of the sheet. There also is an injection granulation apparatus that injects a composition liquid in which a raw material is dispersed in a solution through a nozzle to granulate fine particles of the raw material.

The terms “image formation”, “recording”, “printing”, “image printing”, and “fabricating” used herein may be used synonymously with each other.

The above-described embodiments are limited examples, and the present disclosure includes, for example, the following aspects having advantageous effects.

### Aspect 1

A liquid discharge head provided with a nozzle that discharges a liquid, a substrate including a pressure chamber communicating with the nozzle, and an electromechanical conversion element, the liquid discharge head that drives the electromechanical conversion element to pressurize ink in the pressure chamber and discharge the liquid from the nozzle, in which a surface layer having lyophilicity with respect to the liquid is provided on inner peripheral surfaces of the nozzle and the pressure chamber.

In a liquid discharge head disclosed in Patent Literature 1, since a substrate is etched with a sulfur hexafluoride (SF6) gas to form a pressure chamber, a surface film containing fluorine is formed on inner peripheral surfaces of the pressure chamber and a nozzle, and the inner peripheral surfaces of the pressure chamber and the nozzle have hydrophobicity. As a result, there has been a problem in filling property such that the liquid has difficulty in spreading in a wet manner on the inner peripheral surface of the pressure chamber at the time of filling with the liquid, and bubbles remain at corners of the pressure chamber.

In contrast, in Aspect 1, by providing the lyophilic surface layer on the inner peripheral surfaces of the nozzle and the pressure chamber, the inner peripheral surfaces of the nozzle and the pressure chamber have lyophilicity with respect to the liquid, and the liquid easily adheres to the inner peripheral surfaces of the nozzle and the pressure chamber. As a result, the liquid may spread in a wet manner over entire inner peripheral surfaces of the pressure chamber and the nozzle, the pressure chamber and the nozzle may be satisfactorily filled with the liquid, and the filling property of the liquid may be enhanced.

### Aspect 2

In Aspect 1, the surface layer such as the protective film 11 has hydrophilicity. According to this, as described in the embodiment, when the liquid solvent is aqueous, the liquid may spread in a wet manner over the entire inner peripheral surfaces of the pressure chamber and the nozzle, the pressure chamber and the nozzle may be satisfactorily filled with the liquid, and the filling property of the liquid may be enhanced.

### Aspect 3

In Aspect 1 or 2, the surface layer such as the protective film 11 is a protective layer that prevents erosion by a liquid on the inner peripheral surfaces of the nozzle 2 and the pressure chamber 4.

According to this, it is possible to suppress the erosion of the inner peripheral surfaces of the pressure chamber and the nozzle by the liquid.

### Aspect 4

In Aspect 3, the surface layer such as the protective film 11 at least contains any metal of tantalum (Ta), niobium (Nb), titanium (Ti), hafnium (Hf), zirconium (Zr), and tungsten (W). According to this, as described in the embodiment, it is possible to suppress the erosion of the inner peripheral surfaces of the pressure chamber and the nozzle by the liquid.

### Aspect 5

In Aspect 4, the surface layer such as the protective film 11 contains an oxide of any metal of tantalum (Ta), niobium (Nb), titanium (Ti), hafnium (Hf), zirconium (Zr), and tungsten (W). According to this, as described in the embodiment, it is possible to suppress the erosion of the inner peripheral surfaces of the pressure chamber and the nozzle by the liquid.

### Aspect 6

In Aspect 4, the surface layer such as the protective film 11 is formed of a material obtained by mixing an oxide of any metal of tantalum (Ta), niobium (Nb), titanium (Ti), hafnium (Hf), zirconium (Zr), and tungsten (W) with a silicon oxide.

According to this, as described in the embodiment, the protective film 11 may have hydrophilicity and liquid resistance.

### Aspect 7

In any one of Aspects 1 to 6, a liquid repellent film having liquid repellency against the liquid is formed on a nozzle surface.

According to this, as described in the embodiment, it is possible to suppress the liquid from adhering to the nozzle surface, and it is possible to suppress the liquid discharged from the nozzle 2 from deviating from a desired landing position due to the influence of the liquid adhering to the nozzle surface.

### Aspect 8

In any one of Aspects 1 to 7, the electromechanical conversion element such as a piezoelectric element is provided so as to surround the nozzle 2.

According to this, as described in the embodiment, the droplets may be splashed with a smaller force than that with a general unimorph piezo head, and power saving of the electromechanical conversion element such as the piezoelectric element may be achieved. A liquid chamber area may be reduced, and the head may be downsized. Compared with the unimorph piezo head, selection of the electromechanical conversion element may be increased, and high density of the nozzle may be easily realized.

### Aspect 9

In any one of Aspects 1 to 8, the surface layer is also formed on a surface on a side opposite to a nozzle side of the substrate such as the channel substrate 100 including the pressure chamber 4.

According to this, as described in the embodiment, the step of adhering the masking tape to the surface on the side opposite to the nozzle side of the substrate such as the channel substrate 100 such that the surface layer such as the protective film 11 is not formed becomes unnecessary, and the liquid discharge head may be easily manufactured.

### Aspect 10

In a liquid discharge device provided with at least one of a head tank, a carriage, a supply unit, a maintenance unit, and a main scan moving unit, and a liquid discharge head, the liquid discharge head according to any one of Aspects 1 to 9 is used as the liquid discharge head. According to this, the filling property of the liquid may be enhanced.

### Aspect 11

A liquid discharge apparatus includes the liquid discharge head according to any one of Aspects 1 to 8, or the liquid discharge device according to Aspect 10.

According to this, the filling property of the liquid may be enhanced.

### Aspect 12

A step of stacking a diaphragm 103 on a substrate such as a channel substrate 100, a step of forming an electromechanical conversion element such as a piezoelectric element 5 on the diaphragm 103, a step of forming a nozzle 2, a step of forming a pressure chamber 4 in which a stored liquid is pressurized in the substrate, and a step of forming a surface layer such as a protective film 11 having lyophilicity with respect to the liquid on inner peripheral surfaces of the pressure chamber 4 and the nozzle 2 are included.

According to this, it is possible to manufacture a liquid discharge head having a satisfactory filling property of a liquid.

### Aspect 13

In Aspect 12, the surface layer such as the protective film 11 is formed on the inner peripheral surfaces of the pressure chamber 4 and the nozzle 2 by chemical vapor deposition.

According to this, as described in the embodiment, the surface layer such as the protective film 11 may be satisfactorily formed on the inner peripheral surfaces of the pressure chamber 4 and the nozzle 2.

### Aspect 14

In Aspect 12 or 13, the pressure chamber 4 is formed by dry etching.

According to this, as described in the embodiment, even when the inner wall surface of the pressure chamber 4 or the inner peripheral surface of the nozzle has liquid repellency by the dry etching, it is possible to satisfactorily fill with the liquid.

### Aspect 15

In any one of Aspects 12 to 14, a step of forming a liquid repellent film having liquid repellency against the liquid on a nozzle surface is included.

According to this, it is possible to suppress the liquid from adhering to the nozzle surface, and it is possible to suppress the liquid discharged from the nozzle 2 from deviating from a desired landing position due to the influence of the liquid adhering to the nozzle surface.

### Aspect 16

In Aspect 15, a step of removing the liquid repellent film adhered to the surface layer is included.

According to this, it is possible to prevent the liquid repellent film adhered to the surface layer such as the protective film 11 of the pressure chamber 4 and the nozzle from affecting the filling property of the liquid.

### Aspect 17

A liquid discharge head includes: a nozzle plate having nozzles from each of which a liquid is to be discharged; a substrate including a pressure chamber communicating with the nozzle; an electromechanical conversion element in the nozzle plate, the electromechanical conversion element configured to apply pressure to the ink in the pressure chamber to discharge the liquid from the nozzle; and a lyophilic surface layer lyophilic with the liquid, on an inner peripheral surface of each of the nozzle and the pressure chamber.

### Aspect 18

In the liquid discharge head according to aspect 17, the lyophilic surface layer is hydrophilic.

### Aspect 19

In the liquid discharge head according to aspect 17 or 18, the lyophilic surface layer is a protective layer configured to prevent erosion of the inner peripheral surfaces of each of the nozzle and the pressure chamber by the liquid.

### Aspect 20

In the liquid discharge head according to aspect 19, the lyophilic surface layer contains metal of at least one of tantalum (Ta), niobium (Nb), titanium (Ti), hafnium (Hf), zirconium (Zr), or tungsten (W).

### Aspect 21

In the liquid discharge head according to aspect 19, the lyophilic surface layer contains metal oxide of at least one of tantalum (Ta), niobium (Nb), titanium (Ti), hafnium (Hf), zirconium (Zr), or tungsten (W).

### Aspect 22

In the liquid discharge head according to aspect 19, the lyophilic surface layer contains a mixed material of: metal oxide of at least one of tantalum (Ta), niobium (Nb), titanium (Ti), hafnium (Hf), zirconium (Zr), or tungsten (W); and a silicon oxide.

### Aspect 23

In the liquid discharge head according to any one of aspects 17 to 22, further comprising a liquid repellent film having liquid repellency against the liquid, wherein the nozzle plate has a nozzle surface facing outside the liquid discharge head, and the liquid repellent film is on the nozzle surface of the nozzle plate.

### Aspect 24

In the liquid discharge head according to any one of aspects 17 to 23, the electromechanical conversion element surrounds the nozzle.

### Aspect 25

In the liquid discharge head according to aspect 17 to 24, the lyophilic surface layer is on an inner surface of the nozzle plate opposite to the nozzle surface.

### Aspect 26

A liquid discharge apparatus includes: the liquid discharge head according to any one of aspects 17 to 25; and at least one of: a head tank attached to the liquid discharge head, the head tank configured to accommodate the liquid to be supplied to the liquid discharge head; a carriage mounting the liquid discharge head and the head tank; a supply unit configured to supply the liquid to the head tank; a maintenance unit configured to maintain the liquid discharge head; or a main scan moving unit configured to move the carriage in a main scanning direction.

### Aspect 27

A method for manufacturing a liquid discharge head, the method includes laminating a diaphragm on a substrate; forming an electromechanical conversion element on the diaphragm; forming a nozzle in the substrate; forming a pressure chamber in the substrate, the pressure chamber communicating with the nozzle; and forming a lyophilic surface layer lyophilic with the liquid, on an inner peripheral surface of each of the pressure chamber and the nozzle.

### Aspect 28

In the method according to aspect 27, wherein the forming the lyophilic surface forms the lyophilic surface layer by chemical vapor deposition.

### Aspect 29

The method according to aspect 27 or 28, the forming the pressure chamber forms the pressure chamber by dry etching.

### Aspect 30

In the method according to any one of aspects 27 to 29, the method further comprising: forming a liquid repellent film having liquid repellency against the liquid on a nozzle surface of the substrate opposite to the inner peripheral surface of the pressure chamber.

### Aspect 31

In the method according to aspect 30, the method further includes removing the liquid repellent film adhered to the lyophilic surface layer.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

This patent application is based on and claims priority to Japanese Patent Application No. 2022-038660, filed on Mar. 11, 2022, in the Japan Patent Office, the entire disclosure of which is hereby incorporated by reference herein.

### REFERENCE SIGNS LIST

1 Liquid discharge head
2 Nozzle
3 Common chamber
4 Pressure chamber
5 Piezoelectric element
6 Electrical connection pad
7a First contact
7b Second contact
7c Third contact
7d Fourth contact
7e Fifth contact
8a First insulating film
8b Second insulating film
9a First lead-out wiring
9b Second lead-out wiring
10 Pad opening
11 Protective film
51 First electrode
52 Piezoelectric film
53 Second electrode
100 Channel substrate
101 Drive circuit
102 Wiring
103 Diaphragm
103a Nozzle forming hole
110 Actuator
111 Nozzle forming portion
112 Liquid repellent film
120 Frame
151 First electrode layer
152 Piezoelectric layer
153 Second electrode layer

1. A liquid discharge head, comprising:
a nozzle plate having nozzles from each of which a liquid is to be discharged;
a substrate including a pressure chamber communicating with the nozzle;
an electromechanical converter in the nozzle plate, the electromechanical converter to apply pressure to ink in the pressure chamber to discharge the liquid from the nozzle; and
a lyophilic surface layer having lyophilicity with the liquid, on an inner peripheral surface of each of the nozzle and the pressure chamber.

2. The liquid discharge head according to claim 1, wherein:
the lyophilic surface layer is hydrophilic.

3. The liquid discharge head according to claim 1, wherein:
the lyophilic surface layer is a protective layer to prevent erosion of the inner peripheral surfaces of each of the nozzle and the pressure chamber by the liquid.

4. The liquid discharge head according to claim 3,
wherein the lyophilic surface layer includes metal of at least one of tantalum (Ta), niobium (Nb), titanium (Ti), hafnium (Hf), zirconium (Zr), or tungsten (W).

5. The liquid discharge head according to claim 3,
wherein the lyophilic surface layer includes metal oxide of at least one of tantalum (Ta), niobium (Nb), titanium (Ti), hafnium (Hf), zirconium (Zr), or tungsten (W).

6. The liquid discharge head according to claim 3,
wherein the lyophilic surface layer includes a mixed material of:
metal oxide of at least one of tantalum (Ta), niobium (Nb), titanium (Ti), hafnium (Hf), zirconium (Zr), or tungsten (W); and
a silicon oxide.

7. The liquid discharge head according to claim 1, further comprising:
a liquid repellent film having liquid repellency against the liquid,
wherein:
the nozzle plate has a nozzle surface facing outside the liquid discharge head, and
the liquid repellent film is on the nozzle surface of the nozzle plate.

8. The liquid discharge head according to claim 1, wherein:
the electromechanical converter surrounds the nozzle.

9. The liquid discharge head according to claim 1, wherein:
the nozzle plate has a nozzle surface, and
the lyophilic surface layer is on an inner surface of the nozzle plate opposite to the nozzle surface.

10. A liquid discharge apparatus, comprising:
the liquid discharge head according to claim 1; and
at least one of:
a head tank attached to the liquid discharge head, the head tank to accommodate the liquid to be supplied to the liquid discharge head;
a carriage mounting the liquid discharge head and the head tank;
a supplier to supply the liquid to the head tank;
a maintainer to maintain the liquid discharge head; or
a main scan mover to move the carriage in a main scanning direction.

11. A method for manufacturing a liquid discharge head, the method comprising:
laminating a diaphragm on a substrate;
forming an electromechanical converter on the diaphragm;
forming a nozzle in the substrate;
forming a pressure chamber in the substrate, the pressure chamber communicating with the nozzle; and
forming a lyophilic surface layer having lyophilicity with the liquid, on an inner peripheral surface of each of the pressure chamber and the nozzle.

12. The method according to claim 11, wherein:
the forming the lyophilic surface forms the lyophilic surface layer by chemical vapor deposition.

13. The method according to claim 11, wherein:
the forming the pressure chamber forms the pressure chamber by dry etching.

14. The method according to claim 11, further comprising:
forming a liquid repellent film having liquid repellency against the liquid on a nozzle surface of the substrate opposite to the inner peripheral surface of the pressure chamber.

15. The method according to claim 14, further comprising:
removing the liquid repellent film adhered to the lyophilic surface layer.
